(19) United States
(12) Patent Application Publication
(10) Pub. No.: US 2023/0005486 A1
(43) Pub. Date: Jan. 5, 2023

(54) SPEAKER EMBEDDING CONVERSION FOR BACKWARD AND CROSS-CHANNEL COMPATABILITY

(71) Applicant: Pindrop Security, Inc., Atlanta, GA (US)

(72) Inventors: Tianxiang Chen, Atlanta, GA (US); Elie Khoury, Atlanta, GA (US)

(73) Assignee: Pindrop Security, Inc., Atlanta, GA (US)

(21) Appl. No.: 17/855,149

(22) Filed: Jun. 30, 2022

Related U.S. Application Data
(60) Provisional application No. 63/218,174, filed on Jul. 2, 2021.

(51) Int. Cl. G10L 17/02; G10L 17/04; G10L 17/18

(52) U.S. Cl. CPC G10L 17/02; G10L 17/04; G10L 17/18

(57) ABSTRACT

Embodiments include a computer executing voice biometric machine-learning for speaker recognition. The machine-learning architecture includes embedding extractors that extract embeddings for enrollment or for verifying inbound speakers, and embedding convertors that convert enrollment voiceprints from a first type of embedding to a second type of embedding. The embedding convertor maps the feature vector space of the first type of embedding to the feature vector space of the second type of embedding. The embedding convertor takes as input enrollment embeddings of the first type of embedding and generates as output converted enrolled embeddings that are aggregated into a converted enrolled voiceprint of the second type of embedding. To verify an inbound speaker, a second embedding extractor generates an inbound voiceprint of the second type of embedding, and scoring layers determine a similarity between the inbound voiceprint and the converted enrolled voiceprint, both of which are the second type of embedding.

### CROSS-REFERENCE TO RELATED APPLICATIONS

This application claims priority to U.S. Provisional Application No. 63/218,174, filed Jul. 2, 2021, which is incorporated by reference in its entirety.

This application generally relates to U.S. application Ser. No. 17/165,180, entitled “Cross-Channel Enrollment and Authentication of Voice Biometrics,” filed Feb. 2, 2021, which claims priority to U.S. Provisional Application No. 62/969,484, filed Feb. 3, 2020, each of which is incorporated by reference in its entirety.

This application generally relates to U.S. application Ser. No. 17/066,210, entitled “Z-Vectors: Speaker Embeddings from Raw Audio Using SincNet, Extended CNN Architecture and In-Network Augmentation Techniques,” filed Oct. 8, 2020, which claims priority to U.S. Provisional Application No. 62/914,182, filed Oct. 11, 2019, each of which is incorporated by reference in its entirety.

This application generally relates to U.S. application Ser. No. 15/709,290, entitled “Improvements of Speaker Recognition in the Call Center,” filed Sep. 19, 2017, which claims priority to U.S. Provisional Application No. 62/396,670, filed Sep. 19, 2016, entitled titled “Improvements of Speaker recognition in the Call Center,” each of which is incorporated by reference in its entirety.

### TECHNICAL FIELD

This application generally relates to systems and methods for managing, training, and deploying a machine learning architecture for audio processing.

### BACKGROUND

The accuracy of automatic speaker verification (ASV) systems has been greatly improved due to the recent breakthroughs in low-rank speaker representations and deep learning techniques, leading to the success of ASV in real-world applications from call centers to mobile applications and smart devices. ASV systems, among other types of voice biometrics systems, rely upon speaker embeddings extracted as vectors from one or more voice samples and from a current inbound call requiring authentication. The machine-learning architecture determines a similarity level (e.g., cosine distance) between an enrolled speaker embedding (sometimes called a “voiceprint”) generated for a registered user (or “enrollee”), and an inbound speaker embedding for an inbound user (sometimes called an “inbound voiceprint”). If the distances satisfy a threshold similarity, then the machine-learning architecture determines the inbound user and the enrolled user are likely the same speaker.

Recently, some voice biometric service providers have been shifting the voice biometric systems away from traditional Gaussian Mixture Model (GMM) approaches, from the GMM-based i-vector paradigm towards the deep learning-based x-vector paradigm employing various types of neural networks. Moreover, some voice biometric providers implement different types of communications systems requiring different sampling rates (e.g. 8 kHz over a telephone channel; 16 kHz for communications from VoIP software or virtual assistants).

### SUMMARY

A problem with conventional systems is that speaker embeddings extracted from one ASV system are often not compatible with another ASV system. This renders interchangeability between systems very cumbersome and costly. For example, the different types of machine-learning architectures, generating different types of embedding vectors (e.g., i-vectors or x-vectors), cause incompatibility between the ASV systems. As another example, different sampling rates may cause incompatibility between the ASV systems using the extracted embeddings. As a result, registered enrollees may have to provide additional enrollment signals for the system to generate updated or new enrollment voiceprints for the enrollees, which is cumbersome or aggravating for the enrollees. What is needed is a means for addressing the incompatibility between various types of ASV systems, for backward compatibility to older systems or for cross-compatibility among various types of channel requirements (e.g., sampling rates, bandwidths).

Disclosed herein are systems and methods capable of addressing the above-described shortcomings and may also provide any number of additional or alternative benefits and advantages. Embodiments include a computing device that executes software routines of one or more machine-learning architectures for audio processing and speaker recognition. The machine-learning architecture executes software programming for speaker recognition that include embedding extractors that extract the voiceprint embeddings for enrollees or inbound speakers. The machine-learning architecture further includes embedding convertors that convert existing enrollment voiceprints from a first type of embedding to a second type of embedding. The embedding convertors are trained to map the feature vector space of the first type of embedding to the feature vector space of the second type of embedding. The embedding convertor takes as input the enrollment embeddings or enrolled voiceprint of the first type of embedding and generates a converted enrolled voiceprint of the second type of embedding. To verify an inbound speaker is the enrolled speaker, the second embedding extractor generates an inbound voiceprint of the second type of embedding. Scoring layers of the machine-learning architecture determines a similarity level (e.g., cosine distance) between the inbound voiceprint and the converted enrolled voiceprint. If the scoring layers determine that the similarity score satisfies a threshold similarity score, then the machine-learning architecture determines that the inbound speaker and the enrolled speaker are likely the same speaker.

In an embodiment, a computer-implemented method comprises obtaining, by a computer, a plurality of enrollment embeddings extracted using a plurality of enrollment signals for an enrolled user by applying a first embedding extractor for a first attribute-type; generating, by the computer, a plurality of converted embeddings corresponding to the plurality of enrollment embeddings by applying an embedding convertor comprising a plurality of machine-learning layers trained to generate a converted embedding having a second attribute-type for an enrollment embedding having a first attribute-type; generating, by the computer, a converted enrolled voiceprint having the second attribute-type for the enrolled user based upon the plurality of converted embeddings; generating, by the computer, an inbound voiceprint for an inbound user extracted using an inbound signal for an inbound user by applying a second embedding extractor for the second attribute-type; and generating, by the computer, a similarity score for the inbound signal using the converted enrolled voiceprint and the inbound voiceprint, the similarity score indicating a likelihood that the inbound user is the enrolled user.

In another embodiment, a system comprises a non-transitory machine-readable memory configured to store machine-readable instructions for one or more neural networks; and a computer comprising a processor. The computer configured to obtain a plurality of enrollment embeddings extracted using a plurality of enrollment signals for an enrolled user by applying a first embedding extractor for a first attribute-type; generate a plurality of converted embeddings corresponding to the plurality of enrollment embeddings by applying an embedding convertor comprising a plurality of machine-learning layers trained to generate a converted embedding having a second attribute-type for an enrollment embedding having a first attribute-type; generate a converted enrolled voiceprint having the second attribute-type for the enrolled user based upon the plurality of converted embeddings; generate an inbound voiceprint for an inbound user extracted using an inbound signal for an inbound user by applying a second embedding extractor for the second attribute-type; and generate a similarity score for the inbound signal using the converted enrolled voiceprint and the inbound voiceprint, the similarity score indicating a likelihood that the inbound user is the enrolled user.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows components of a system for receiving and analyzing telephone calls for voice biometrics received from various types of communication channels or devices, according to an embodiment.

FIG. 2 shows steps of a method for training a machine-learning architecture for speaker verification, including functions or layers defining embedding extractors and one or more embedding convertors, according to an embodiment.

FIG. 3 shows steps of a method for implementing a machine-learning architecture for speaker verification, including functions or layers defining embedding extractors and one or more embedding convertors, according to an embodiment.

FIG. 4 shows data flow amongst layers of a machine-learning architecture for speaker recognition including embedding convertors, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

In a typical voice biometric system, the embedding extraction engine computes or extracts an embedding as a feature vector mathematically representing low-level features of a speaker's utterance contained in an audio signal. When enrolling the enrolled speaker, the computing device mathematically combines or aggregates multiple enrollment embeddings from the same enrollee-speaker to create the enrolled voiceprint for a user profile of the enrolled speaker. Once the user profile is created, and the machine-learning architecture receives a new verification or authentication request, the embedding extractor generates an inbound voiceprint for an inbound speaker. Scoring layers generate a similarity score (e.g., cosine distance, probabilistic linear discriminant analysis (PLDA)) to compare the enrolled voiceprint embedding against the inbound voiceprint and verify the likelihood that the enrolled speaker is the inbound speaker.

Embodiments described herein include a server or other computing devices executing software implementing a machine-learning architecture that comprises layers and functions defining a voice biometric system, such as ASV or voice biometrics authentication. Layers of the machine-learning architecture define speaker embedding extraction engines (sometimes referred to as “embedding extractors”) and one or more embedding conversion engines (sometimes referred to as “embedding convertors”). The voice biometrics engine is trained to recognize and distinguish instances of speech of audio signals, such as a speaker recognition engine. Layers of the speaker recognition engine define an input layer that performs pre-processing operations for extracting various types of features from the audio signals and applies a transform operation on the features. An embedding extractor of the machine-learning architecture extracts a feature vector embedding representing the features of an utterance of the particular audio signal. One or more output or scoring layers then generates certain results according to corresponding input audio signals and evaluates the results, which may include a classifier or other scoring layer.

During a training phase, the machine-learning architecture includes a loss function that compares an observed (or “predicted”) output (e.g., predicted embedding) against an expected output (e.g., expected embedding), based upon a training label or cluster centroid. The training operations then tailor the weighted values of the machine-learning architecture (sometimes called “hyper-parameters”) and reapply the machine-learning architecture on the same or additional training input signals until the expected outputs and observed outputs converge. The server then fixes (e.g., freezes or sets) the hyper-parameters and, in some cases, disables one or more layers of the machine-learning architecture used for training.

The server can further train the speaker recognition engine to recognize a particular speaker during an enrollment phase for the particular enrollee-speaker. The speech recognition engine can generate an enrollee voice feature vector (sometimes called a “voiceprint”) using enrollee audio signals having speech segments involving the enrollee. During a later deployment phase (sometimes referred to as “test phase,” “testing,” “production,” or “verification”), the server receives and applies the machine-learning architecture on an inbound phone call to verify an inbound speaker. The speaker recognition engine compares the enrolled voiceprints in order to confirm whether the inbound speaker in the inbound audio signal is the enrolled user, based upon matching an inbound feature vector embedding extracted from the inbound audio signal against the enrolled voiceprint of the enrollee. These approaches are generally successful and adequate for detecting the enrollee in the inbound audio signal.

Voice biometrics for speaker recognition and other operations (e.g., authentication) often rely upon vectors generated from a universe of training speaker samples and samples of a particular enrolled speaker. For example, enrollment audio signals having lower sampling rates (e.g., 8 kHz of enrollment voice samples received via landline phone channel) resulting in enrollment feature vectors or enrolled voiceprints based upon those features generated from the lower-sampling rate enrollment signals. These enrolled voiceprints are often incompatible with, or not suitable for comparison against, inbound voiceprints extracted from an inbound calls arriving through a higher-sampling rate communication channel (e.g., 16 kHz of an inbound call received via data channel). As another example, a first embedding extractor may apply a Gaussian Matrix Model (GMM) machine-learning technique for extracting enrolled feature vectors and generating an enrolled voiceprint. These enrolled voiceprints are often incompatible with, or not suitable for comparison against, inbound voiceprints generated using a second embedding extractor that applies a neural network architecture.

The embedding convertors enable the voice biometric machine-learning architecture to perform speaker recognition for an enrolled-speaker based upon enrolled audio signals or enrolled embeddings having disparate signal or embedding attributes, different from the attributes of the inbound embeddings or inbound signals. Each embedding convertor maps an input embedding vector space to an output embedding vector space to generate a converted embedding resulting from and corresponding to the input embedding. The embedding convertor comprises a neural network architecture having layers for a deep learning neural network (DNN). The DNN takes an existing embedding vector (for a first type of embedding from a first embedding extractor) as input and outputs the new converted embedding (for a second type of embedding from a second embedding extractor).

During a training phase, the embedding convertor is trained to minimize a distance (e.g., cosine distance) between predicted converted embeddings when compared against expected converted embeddings. The expected converted embeddings may be indicated by training labeled data associated with the training audio signals or training embeddings. Additionally or alternatively, the expected converted embeddings may be actual embeddings generated by the second type of embedding extractor for the training audio signals. A database stores the trained components or sub-components of the machine-learning architecture, including the trained embedding extractors and embedding convertors.

During an enrollment phase, when registering a new user through a particular channel or using an existing embedding extraction technique, the machine-learning architecture may apply the first embedding extractor on enrollment signals from the enrollee-user. The speaker recognition engine extracts enrollment feature vectors from the enrollment signals and may algorithmically combine the enrollment feature vectors to generate a first type of enrollment voiceprint for the first embedding extractor. For instance, the first embedding extractor may apply the GMM technique for generating feature vectors (e.g., i-vectors).

At a following point-in-time, the machine-learning architecture applies the embedding convertor on the existing enrolled voiceprint based on the first embedding extractor, thereby outputting a converted enrolled voiceprint as though generated by a second embedding extractor. For instance, the second embedding extractor applies a DNN technique for generating feature vectors (e.g., x-vectors). Additionally or alternatively, the machine-learning architecture applies the embedding convertor on the set of enrollment embedding vectors, thereby outputting a set of corresponding enrollment converted embeddings, which the machine-learning architecture aggregates to generate a converted enrolled voiceprint. The machine-learning architecture may execute the embedding convertor at any later point-in-time or triggering operation. Non-limiting examples may include: contemporaneously or shortly after generating the first type of enrollment voiceprint; during a deployment phase in response to instructions to verify an inbound speaker; when implementing a new machine-learning architecture for different types of audio signal attributes (e.g., 8 kHz sampling rate signals, 16 kHz sampling rate signals); and when implementing a new machine-learning architecture for different types of embeddings (e.g., i-vectors, x-vectors), among other circumstances. For a particular enrolled user, the database stores information about the enrolled user as a user profile, including, for example, the enrollment audio signals, enrollment embeddings, enrolled voiceprints, converted enrollment embeddings, and converted enrolled voiceprints, among other types of data.

During a deployment phase, the machine-learning architecture applies the second embedding extractor to extract an inbound voiceprint for an inbound user. The machine-learning architecture then applies scoring layers on the inbound voiceprint and the converted enrolled voiceprint to generate a similarity score. The similarity score indicates a similarity or distance between the inbound voiceprint and the enrolled voiceprint, and represents a likelihood that the inbound speaker is the enrolled speaker. The server determines that the inbound speaker is the enrolled speaker when the similarity score satisfies a matching threshold value.

The machine-learning architecture may include any number of layers configured to perform certain operations, such as input layers for audio data ingestion, pre-processing operations, data augmentation operations, loss function operations, and classification operations, among others. It should be appreciated that the layers or operations may be performed by any number of machine-learning architectures. Moreover, certain operations, such as pre-processing operations and data augmentation operations or may be performed by a computing device separately from the machine-learning architecture or as layers of the machine-learning architecture.

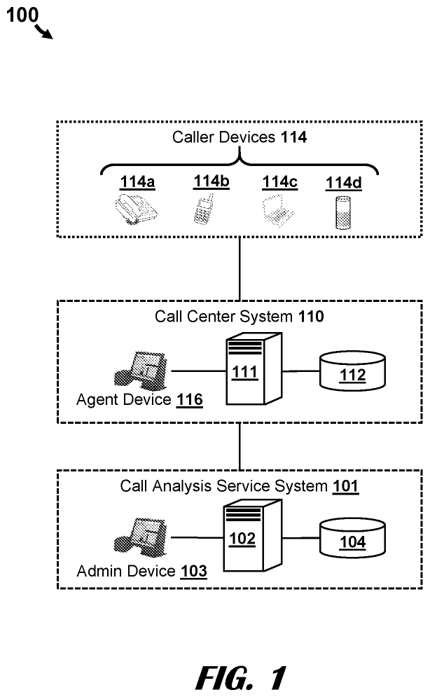

FIG. 1 shows components of a system 100 for receiving and analyzing telephone calls for voice biometrics received from various types of communication channels or devices. The system 100 comprises a call analytics system 101, any number of call center systems 110 of service provider enterprise infrastructures (e.g., companies, government entities, universities), and end-user devices 114a-114d (collectively referred to as “end-user device 114” or “end-user devices 114”). The call analytics system 101 includes analytics servers 102, analytics databases 104, and admin devices 103. The call center system 110 includes call center servers 111, call center databases 112, and agent devices 116. Embodiments may comprise additional or alternative components or omit certain components from those of FIG. 1, and still fall within the scope of this disclosure. It may be common, for example, to include multiple call center systems 110 or for the call analytics system 101 to have multiple analytics servers 102. Embodiments may include or otherwise implement any number of devices capable of performing the various features and tasks described herein. For example, the FIG. 1 shows the analytics server 102 in as a distinct computing device from the analytics database 104. In some embodiments, the analytics database 104 may be integrated into the analytics server 102.

It should be appreciated that embodiments described with respect to FIG. 1 are merely examples of a voice biometrics processing system described herein and not necessarily limiting on other potential embodiments. The description of FIG. 1 mentions circumstances in which a caller places a call through various communications channels or using various types of end-user devices 114 to contact and interact with the services offered by the call center system 110, though the operations and features of the analytics system 101, including the voice biometrics machine-learning techniques, described herein may be applicable to any circumstances involving a voice-based interface or speaker recognition and not limited to uses cases between the caller and the services offered by the call center system 110. The features described herein may be implemented in any system that receives and authenticates speaker audio inputs via multiple communications channels or end-user devices 114.

The end-users may access user accounts or other features of the service provider and the call center system 110 and interact with human agents of or with software applications (e.g., cloud application) hosted by call center servers 111. In some implementations, the users of the service call center system 110 may access the user accounts or other features of the service provider by placing calls using the various types of user devices 114. The users may also access the user accounts or other features of the service provider using software executed by certain user devices 114 configured to exchange data and instructions with software programming (e.g., the cloud application) hosted by the call center servers 111. The call center system 110 may include, for example, human agents who converse with callers during telephone calls, Interactive Voice Response (IVR) software executed by the call center server 111, or cloud software programming executed by the call center server 111 accessible to software executed by the end-user devices 114. The call center system 110 need not include any human agents such that the end-user interacts only with the IVR system or the cloud software application.

The customer call center system 110 includes human agents (operating the agent devices 116) and/or an IVR system (hosted by the call center server 111) that handle telephone calls originating from, for example, landline devices 114a or mobile devices 114b having different types of attributes. Additionally or alternatively, the call center server 111 executes the cloud application that is accessible to a corresponding software application on a user device 114, such as a mobile device 114b, computing device 114c, or edge device 114d. The user interacts with the user account or other features of the service provider using the user-side software application. In such cases, the call center system 110 need not include a human agent or the user could instruct call center server 111 to redirect the software application to connect with an agent device 116 via another channel, thereby allowing the user to speak with a human agent when the user is having difficulty.

Various hardware and software components of one or more public or private networks may interconnect the various components of the system 100 via various communications channels. Non-limiting examples of such networks may include: Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols. Likewise, the end-user devices 114 may communicate with callees (e.g., call center systems 110) via telephony and telecommunications protocols, hardware, and software capable of hosting, transporting, and exchanging audio data associated with telephone calls. Non-limiting examples of telecommunications hardware may include switches and trunks, among other additional or alternative hardware used for hosting, routing, or managing telephone calls, circuits, and signaling. Non-limiting examples of software and protocols for telecommunications may include SS7, SIGTRAN, SCTP, ISDN, and DNIS among other additional or alternative software and protocols used for hosting, routing, or managing telephone calls, circuits, and signaling. Components for telecommunications may be organized into or managed by various different entities, such as carriers, exchanges, and networks, among others.

The end-user devices 114 may be any communications device or computing device that the caller operates to access the services of the call center system 100 through the various types of communications channels. For instance, the caller may place the call to the call center system 110 through a telephony network or through a software application executed by the end-user device 114. Non-limiting examples of end-user devices 114 may include landline phones 114a, mobile phones 114b, computing devices 114c, or edge devices 114d. The landline phones 114a and mobile phones 114b are telecommunications-oriented devices (e.g., telephones) that communicate via telephony channels. The end-user device 114 is not limited to the telecommunications-oriented devices or channels. For instance, in some cases, the mobile phones 114b may communicate via a computing network channel (e.g., the Internet). The end-user device 114 may also include an electronic device comprising a processor and/or software, such as a computing device 114c or edge device 114d implementing, for example, voice-over-IP (VoIP) telecommunications, data streaming via a TCP/IP network, or other computing network channel. The edge device 114d may include any Internet of Things (IoT) device or other electronic device for network communications. The edge device 114d could be any smart device capable of executing software applications and/or performing voice interface operations. Non-limiting examples of the edge device 114d may include voice assistant devices (e.g., Amazon Echo®, Google Home®), automobiles, smart appliances, and the like.

The call center system 110 comprises various hardware and software components that capture and store various types of data or metadata related to the caller's contact with the call center system 110. This data may include, for example, audio recordings of the call or the caller's voice and metadata related to the protocols and software employed for the particular communication channel. The audio signal captured with the caller's voice has a quality based on the particular communication used. For example, the audio signals from the landline phone 114a will have a lower sampling rate and/or lower sampling rate compared to the sampling rate and/or sampling rate of the audio signals from the edge device 114d.

The call analytics system 101 and the call center system 110 represent network infrastructures 101, 110 comprising physically and logically related software and electronic devices managed or operated by various enterprise organizations. The devices of each network system infrastructure 101, 110 are configured to provide the intended services of the particular enterprise organization.

The analytics server 102 of the call analytics system 101 may be any computing device comprising one or more processors and software, and capable of performing the various processes and tasks described herein. The analytics server 102 may host or be in communication with the analytics database 104, and receives and processes call data (e.g., audio recordings, metadata) received from the one or more call center systems 110. Although FIG. 1 shows only a single analytics server 102, the analytics server 102 may include any number of computing devices. In some cases, the computing devices of the analytics server 102 may perform all or sub-parts of the processes and benefits of the analytics server 102. The analytics server 102 may comprise computing devices operating in a distributed or cloud computing configuration and/or in a virtual machine configuration. It should also be appreciated that, in some embodiments, functions of the analytics server 102 may be partly or entirely performed by the computing devices of the call center system 110 (e.g., the call center server 111).

The analytics server 102 executes software programming for performing the various audio or data processing operations for verifying speakers or users. The software includes one or more machine-learning architectures, which may include functions or layers that define certain functional operations (sometimes referred to as “engines”) and/or perform various types of machine-learning techniques, such as Gaussian Mixture Models (GMMs), convolutional neural networks (CNNs), and deep neural networks (DNNs), among others. For ease of description, the analytics server 102 in the example system 100 executes a single machine-learning architecture, though the analytics server 102 may execute any number of machine-learning architectures in other embodiments.

The machine-learning architecture includes functions or layers defining embedding extractors and embedding convertors. The embedding extractors extract feature vectors according to various types of signal or embedding attributes, such as a types or dimensions of feature vectors (e.g., i-vectors, x-vectors, z-vectors), a sampling rate, a bandwidth of a communication channel through which an audio signal is received, or other attributes of the signals. In some cases, an embedding extractor may include functions and layers for extracting a type of feature vector embedding using a GMM-based machine-learning technique, which outputs GMM-based feature vectors (e.g., i-vectors). Non-limiting examples of embodiments implementing machine-learning architectures for generating feature vectors using GMMs are described in U.S. application Ser. No. 15/709,290, entitled “Improvements of Speaker Recognition in the Call Center,” which is incorporated by reference in its entirety. In some cases, an embedding extractor may include functions and layers for extracting another type of feature vector embedding using a DNN-based machine-learning technique, which output DNN-based feature vectors (e.g., x-vectors). Non-limiting examples of embodiments implementing machine-learning architectures for generating feature vectors using DNNs or CNNs are described in U.S. application Ser. No. 17/165,180, entitled “Cross-Channel Enrollment and Authentication of Voice Biometrics,” filed Feb. 2, 2021.

The analytics server 102 executes the machine-learning architecture operates logically in several operational phases, including a training phase, an enrollment phase, and a deployment phase (sometimes referred to as a “test phase,” “testing,” or “production”), though some embodiments need not perform the enrollment phase. The inputted audio signals processed by the analytics server 102 and the machine-learning architecture include training audio signals, enrollment audio signals, and inbound audio signals processed during the deployment phase. The analytics server 102 applies the machine-learning architecture to each type of inputted audio signal (e.g., training signal, enrollment signal, inbound signal) during the corresponding operational phase (e.g., training phase, enrollment phase, deployment phase).

The analytics server 102 or other computing device of the system 100 (e.g., call center server 111) performs various pre-processing operations or data augmentation operations on the input audio signals. Non-limiting examples of pre-processing operations on inputted audio signals include: extracting low-level features, parsing or segmenting the audio signal into frames or segments, and performing one or more transformation functions (e.g., FFT, SFT), among other potential pre-processing operations. Non-limiting examples of augmentation operations include performing down-sampling, audio clipping, noise augmentation, frequency augmentation, and duration augmentation, among others. The analytics server 102 may perform the pre-processing or data augmentation operations prior to feeding the input audio signals into input layers of the machine-learning architecture. Additionally or alternatively, the analytics server 102 performs pre-processing or data augmentation operations when executing the machine-learning architecture, where the input layers (or other layers) of the machine-learning architecture perform the pre-processing or data augmentation operations. In some cases, the machine-learning architecture may comprise in-network data augmentation layers that perform data augmentation operations on the input audio signals fed into the neural network architecture.

During the training phase, the analytics server 102 receives training audio signals of various lengths and attributes (e.g., sample rate, types of degradation, bandwidth) from one or more corpora, which may be stored in an analytics database 104 or other storage medium. In some embodiments, the training audio signals may include clean audio signals (sometimes referred to as samples) and simulated or degraded audio signals, each of which the analytics server 102 uses to train the various sub-components of the machine-learning architecture. The analytics server 102 applies the machine-learning architecture on the training audio signals to train the various sub-components, such as the embedding extractors, embedding convertors, scoring layers, classifier layers, feature extraction layers, and pre-processing layers, among others.

In some cases, the data augmentation operations of the machine-learning architecture may generate simulated or degraded audio signals for a given input audio signal (e.g., training signal, enrollment signal), in which the simulated or degraded audio signal contains manipulated features of the input audio signal mimicking the effects a particular type of signal degradation or distortion on the input audio signal. The analytics server 102 stores the training audio signals into the non-transitory medium of the analytics server 102 and/or the analytics database 104 for future reference or operations of the machine-learning architecture, including current or future data augmentation operations for the training or enrollment phases.

During the training phase and, in some implementations, the enrollment phase, the embedding extractor outputs predicted embeddings and the embedding convertors outputs predicted converted embeddings. One or more fully-connected and/or feed-forward layers generate and output predicted embeddings or the predicted converted embeddings for the training audio signals. Loss layers perform various loss functions to evaluate the distances between the predicted embeddings or predicted converted embedding and expected embeddings or expected converted embeddings, as indicated by labels associated with training signals or enrollment signals. The loss layers, or other functions of the machine-learning architecture, tune the hyper-parameters of the sub-components of the machine-learning architecture until the distance between the predicted embedding and the expected embedding satisfies a training threshold distance, or the predicted converted embedding and the expected converted embedding satisfies a training threshold distance.

During the enrollment operational phase, an enrollee speaker provides (to the call analytics system 101) a number of enrollee audio signals containing examples of the enrollee speech. As an example, the enrollee could respond to various interactive voice response (IVR) prompts of IVR software executed by a call center server 111 via a telephone channel. As another example, the enrollee could respond to various prompts generated by the call center server 111 and exchanged with a software application of the edge device 114d via a corresponding data communications channel. The call center server 111 then forwards the recorded responses containing bona fide enrollment audio signals to the analytics server 102. The analytics server 102 applies the trained machine-learning architecture to each of the enrollee audio samples and generates corresponding enrollment feature vectors or converted enrollment embedding. In some implementations, the analytics server 102 disables certain layers, such as layers employed for training the machine-learning architecture. In some cases, the analytics server 102 generate an averages or otherwise algorithmically combines the enrollment embeddings extracted by the embedding extractor into an enrolled voiceprint and stores the enrollee embeddings and the enrolled voiceprint into the analytics database 104 or the call center database 112. Additionally or alternatively, the analytics server 102 generates converted embeddings of a second-type corresponding to the enrollment embeddings of the first-type, as extracted by the embedding extractor. The machine-learning architecture averages or otherwise algorithmically combines the converted enrollment embeddings into a converted enrolled voiceprint and stores the converted enrolled voiceprint into the analytics database 104 or the call center database 112. Similar details of the training and enrollment phases for the speaker verification neural network have described in U.S. patent application Ser. No. 17/066,210, which is incorporated by reference.

Following the training phase, the analytics server 102 stores the trained machine-learning architecture and sub-components (e.g., trained embedding extractors, trained embedding convertors) into the analytics database 104 or call center database 112. When a call center server 111, agent device 116, admin device 103, or user device 114 instructs the analytics server 102 to enter an enrollment phase for extracting features of enrollee audio signals or tuning the tuning the machine-learning architecture for the enrollee audio signals, the analytics server 102 retrieves the trained machine-learning architecture from the database 104, 112. The analytics server 102 then stores the extracted enrollee embeddings and trained machine-learning architecture into the database 104, 112 for the deployment phase.

During the deployment phase, the analytics server 102 receives the inbound audio signal of the inbound call, as originated from the end-user device 114 of an inbound caller through a particular communications channel. The analytics server 102 applies machine-learning architecture on the inbound audio signal to extract the inbound features from the inbound audio signal, generates an inbound voiceprint, and determines whether the inbound speaker is an enrollee by comparing the inbound voiceprint against the converted enrolled voiceprint for enrollee.

During deployment, the analytics server 102 applies the operational layers of the machine-learning architecture, such as the input layers (e.g., pre-processing layers) and the embedding extraction layers on the inbound audio signal, thereby extracting the inbound voiceprint. In some embodiments, the analytics server 102 may disable certain layers employed for training or enrollment (e.g., classification layers, loss layers). The machine-learning architecture applies the scoring layers of the machine-learning architecture on the inbound voiceprint and the converted enrolled voiceprint, where both the inbound voiceprint and the converted enrolled voiceprint are the same type of embedding.

In some cases, the machine-learning architecture includes a plurality of trained embedding convertors and converted enrolled voiceprints. For instance, the identification server 102 may train three embedding convertors for converting embeddings between the three types of embeddings. In such cases, the analytics server 102 evaluates the types of signal or embedding attributes of the inbound signal or inbound voiceprint to determine which of the converted enrollment embeddings to compare against the inbound embedding.

In some embodiments, following the deployment phase, the analytics server 102 (or another device of the system 100) may execute any number of various downstream operations employing the converted enrollment voiceprint, the verification determine, or other outputs of the scoring layers, where the downstream operations may include, for example, a speaker authentication operation or speaker diarization.

The analytics database 104 and/or the call center database 112 may contain any number of corpora of training audio signals that are accessible to the analytics server 102 via one or more networks. In some embodiments, the analytics server 102 employs supervised training to train the neural network, where the analytics database 104 includes labels associated with the training audio signals that indicate, for example, the signal attributes (e.g., sampling rate, bandwidth) or features of the training signals. The analytics server 102 may also query an external database (not shown) to access a third-party corpus of training audio signals or training embeddings. An administrator may configure the analytics server 102 to select the training audio signals having certain sampling rates or other characteristics.

In some embodiments, the call center server 111 of a call center system 110 executes software processes for managing a call queue and/or routing calls made to the call center system 110 through the various channels, where the processes may include, for example, routing calls to the appropriate call center agent devices 116 based on the inbound caller's comments, instructions, IVR inputs, or other inputs submitted during the inbound call. The call center server 111 can capture, query, or generate various types of information about the call, the caller, and/or the end-user device 114 and forward the information to the agent device 116, where a graphical user interface (GUI) of the agent device 116 displays the information to the call center agent. The call center server 111 also transmits the information about the inbound call to the call analytics system 101 to preform various analytics processes on the inbound audio signal and any other audio data. The call center server 111 may transmit the information and the audio data based upon preconfigured triggering conditions (e.g., receiving the inbound phone call), instructions or queries received from another device of the system 100 (e.g., agent device 116, admin device 103, analytics server 102), or as part of a batch transmitted at a regular interval or predetermined time.

The admin device 103 of the call analytics system 101 is a computing device allowing personnel of the call analytics system 101 to perform various administrative tasks or user-prompted analytics operations. The admin device 103 may be any computing device comprising a processor and software, and capable of performing the various tasks and processes described herein. Non-limiting examples of the admin device 103 may include a server, personal computer, laptop computer, tablet computer, or the like. In operation, the user employs the admin device 103 to configure the operations of the various components of the call analytics system 101 or call center system 110 and to issue queries and instructions to such components.

The agent device 116 of the call center system 110 may allow agents or other users of the call center system 110 to configure operations of devices of the call center system 110. For calls made to the call center system 110, the agent device 116 receives and displays some or all of the relevant information associated with the call routed from the call center server 111.

Machine-Learning Architecture Training

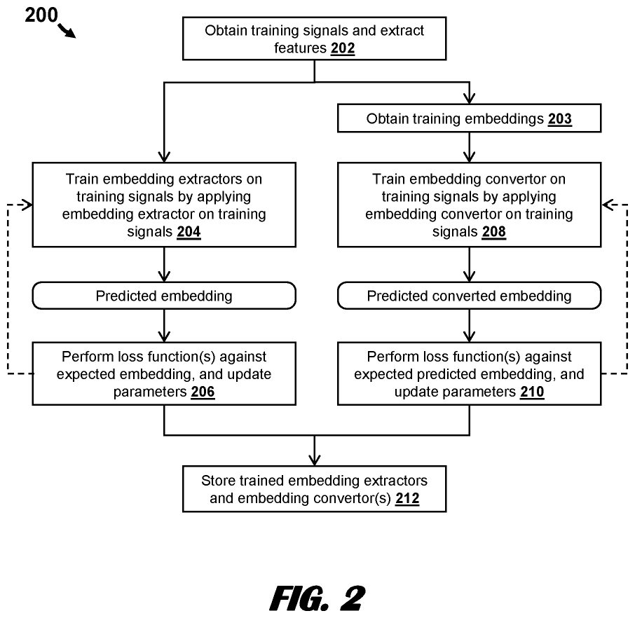

FIG. 2 shows steps of a method 200 for training a machine-learning architecture for speaker verification, including functions or layers defining embedding extractors and one or more embedding convertors. Embodiments may include additional, fewer, or different operations than those described in the method 200. The method 200 is performed by a server executing machine-readable software code of the neural network architectures, though it should be appreciated that the various operations may be performed by one or more computing devices and/or processors.

In operation 202, the server obtains one or more training signals and extracts various types of features used for generating feature vectors, which the machine-learning architecture references, in turn, for verifying speakers or speaker devices. The server obtains the training signals by retrieving the training signals from a database or other data source. The server places the machine-learning architecture or sub-components of the machine-learning architecture (e.g., embedding extractors, embedding convertors) into a training operational phase, and obtains any number of training audio signals (sometimes thousands, hundreds of thousands, or more). The training audio signals may include any combination or permutation of types of signal attributes, such as a mixture of sampling rates (e.g., 8 kHz training signals, 16 kHz training signals).

The machine-learning architecture may include various types of input layers for performing pre-processing operations and, in some implementations, data augmentation operations. The server or layers of the machine-learning architecture may perform various pre-processing operations on an input audio signal (e.g., training audio signal, enrollment audio signal, inbound audio signal). The pre-processing operations may include, for example, extracting low-level features from the audio signals and transforming such features from a time-domain representation into a frequency-domain representation by executing a transform operation, such as Fast-Fourier Transform (FFT) or Sparse-Fourier Transform (SFT) operations. The pre-processing operations may also include parsing the audio signals into frames or sub-frames, and performing various normalization or scaling operations. Optionally, the server performs any number of pre-processing operations prior to feeding the audio data into input layers of the machine-learning architecture. The server may perform the various pre-processing operations in one or more of the operational phases, though the particular pre-processing operations performed may vary across the operational phases. The server may perform the various pre-processing operations separately from the machine-learning architecture or as in-network layer of the machine-learning architecture.

The server or layers of the machine-learning architecture may perform various augmentation operations on the input audio signal (e.g., training audio signal, enrollment audio signal). The augmentation operations generate various types of distortion or degradation for the input audio signal, such that the resulting audio signals are ingested by, for example, convolutional operations. The server may perform the various augmentation operations as separate operations from the neural network architecture or as in-network augmentation layers. Moreover, the server may perform the various augmentation operations in one or more of the operational phases, though in some cases, the particular augmentation operations performed may be different across each of the operational phases.

In operation 204, the server trains one or more the embedding extractors by applying each embedding extractors on the training features extracted from the training signals. The server applies each embedding extractor to each of the training audio signal to train the layers of embedding extractor, thereby training the embedding extractor to produce a predicted embedding for a given input signal.

In operation 206, the server performs one or more loss functions of the embedding extractors using the predicted embedding and updates any number of hyper-parameters of the machine-learning architecture. The embedding extractor (or other layers of the machine-learning architecture) comprises one or more loss layers for evaluating the level of error of the embedding extractor. The loss function determines the level of error of the embedding extractor based upon a similarity score indicating an amount of similarity (e.g., cosine distance) between a predicted output (e.g., predicted embedding, predicted classification) generated by the embedding extractor against an expected output (e.g., expected embedding, expected classification).

In some implementations, the server references training label data associated with the training signals indicating the expected output for the training signal. The training signals include various information indicating, for example, the values or features of an expected embedding corresponding to the training signal. The loss layers may perform various loss functions (e.g., means-square error loss function) based upon the level of error (e.g., differences, similarities) between the predicted embedding and the expected embedding. The loss layers may adjust the weights or hyper-parameters of the embedding extractor (or other component of the machine-learning architecture) to improve the level of error for the embedding extractor, until a threshold level of error is satisfied.

In operation 212, when training is completed, the server stores the hyper-parameters into a database or memory of the server. In some implementations, the server may enable or disable one or more layers of the embedding extractor in order to keep the hyper-parameters fixed.

Optionally, in operation 203, the server obtains training embeddings for training one or more embedding convertors. In some cases, the server obtains the training embeddings by retrieving the training embeddings from a database. In some cases, the server obtains the training embeddings by applying an embedding extractor on training signals (obtained in 202).

In operation 208, the server trains the embedding convertors of the machine-learning architecture by applying each embedding convertor on training embeddings of one or more types of embeddings. The server applies the machine-learning architecture on each type of the training embedding to train layers of the embedding convertor and, in some cases, one or more additional layers (e.g., fully-connected layers), thereby training the neural network architecture to convert embeddings of one type to embeddings of another type.

In operation 210, the server performs one or more loss functions of the embedding convertors using predicted converted embeddings and expected converted embeddings and updates any number of hyper-parameters of the embedding convertors. The embedding convertor (or other layers of the machine-learning architecture) comprises one or more loss layers for evaluating the level of error of the embedding convertor. The loss function determines the level of error of the embedding convertor based upon a similarity score indicating an amount of similarity (e.g., cosine distance) between a predicted output (e.g., predicted converted embedding, predicted classification) generated by the embedding convertor against an expected output (e.g., expected converted embedding, expected classification).

In some implementations, the server references training label data associated with the training signals (and/or training embeddings) indicating the expected converted embedding for the training signal. The training signals include various information indicating, for example, the values or features of an expected converted embedding corresponding to the training signal. The loss layers may perform various loss functions (e.g., means-square error loss function) based upon the level of error (e.g., differences, similarities) between the predicted converted embedding and the expected converted embedding. The loss layers may adjust the weights or hyper-parameters of the embedding convertor (or other component of the machine-learning architecture) to improve the level of error for the embedding convertor, until a threshold level of error is satisfied.

In operation 212, when training is completed, the server stores the hyper-parameters for the embedding convertor into a database or memory of the server. In some implementations, the server may enable or disable one or more layers of the embedding convertor in order to keep the hyper-parameters fixed.

User Enrollment and Speaker Verification

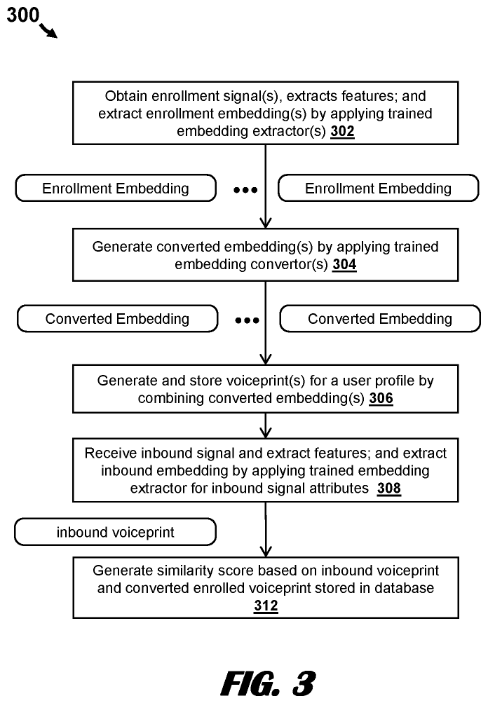

FIG. 3 shows steps of a method 300 for implementing a machine-learning architecture for speaker verification, including functions or layers defining embedding extractors and one or more embedding convertors. Embodiments may include additional, fewer, or different operations than those described in the method 300. The method 300 is performed by a server executing machine-readable software code of the neural network architectures, though it should be appreciated that the various operations may be performed by one or more computing devices and/or processors.

In operation 302, the server obtains enrollment signals, extracts features from the enrollment signals, and extracts the enrollment embeddings by applying one or more trained embedding extractors. The server may obtain the enrollment signals by retrieving the enrollment signals for an enrollee-speaker from a database, or by prompting the enrollee-speaker to provide spoken responses to various prompts. The server places the machine-learning architecture or sub-components of the machine-learning architecture (e.g., embedding extractors, embedding convertors) into an enrollment operational phase, and obtains any number of enrollment audio signals for the enrollee.

The machine-learning architecture may include various types of input layers for performing pre-processing operations and, in some implementations, data augmentation operations for the enrollment signals. The server or layers of the machine-learning architecture may perform various pre-processing operations on the enrollment audio signal. The pre-processing operations may include, for example, extracting low-level features from the enrollment audio signals and transforming such features from a time-domain representation into a frequency-domain representation by executing a transform operation, such as Fast-Fourier Transform (FFT) or Sparse-Fourier Transform (SFT) operations. The pre-processing operations may also include parsing the enrollment audio signals into frames or sub-frames, and performing various normalization or scaling operations. Optionally, the server performs any number of pre-processing operations prior to feeding the enrollment audio signal into the input layers of the machine-learning architecture.

The server or layers of the machine-learning architecture may perform various augmentation operations on the enrollment audio signal. The augmentation operations generate various types of distortion or degradation for the enrollment audio signal, such that the resulting enrollment audio signals are ingested by, for example, convolutional operations of the embedding extractors or embedding convertors. The server may perform the various augmentation operations as separate operations from the neural network architecture or as in-network augmentation layers. Moreover, the server may perform the various augmentation operations in one or more of the operational phases, though in some cases, the particular augmentation operations performed may be different across each of the operational phases.

After extracting the enrollment features from the enrollment signals, the server applies a trained embedding extractor on the enrollment features. The embedding extractor outputs an enrollment embedding based upon certain types of attributes of the enrollment signals and/or a type of machine-learning technique employed by the embedding extractor. For example, where the enrollment signals have 8 kHz sampling rate, the enrollment embeddings reflect the 8 kHz enrollment signals and a first embedding extractor is trained to extract the enrollment embeddings having the 8 kHz sampling rate. As another example, the first embedding extractor implementing layers of a GMM technique, trained to extract the enrollment embeddings that reflect the GMM technique implemented by the first embedding extractor.

In operation 304, the server generates converted embedding(s) by applying trained embedding convertor(s). The embedding convertor comprises layers that map the feature vector space of a first type of embedding to the feature vector space of a second type of embedding. The embedding convertor takes as input the enrollment embeddings of the first type of embedding and generates as output corresponding, converted enrollment embeddings of the second type of embedding.

For example, the first type of embedding includes the enrollment embeddings extracted for the enrollment signals having 8 kHz sampling rate using the first embedding extractor. The server applies the embedding convertor on the enrollment embeddings to convert the enrollment embeddings to a second type of embedding that a second enrollment extractor would otherwise generate. In this example, the embedding convertor generates converted enrollment embeddings that reflect signals having 16 kHz sampling rate.

As another example, the first type of embedding includes the enrollment embeddings extracted by the first embedding extractor according to the GMM technique. The server applies the embedding convertor on the enrollment embeddings to convert the enrollment embeddings to the second type of embedding that a second enrollment extractor would otherwise generate according to a DNN technique. In this example, the embedding convertor generates converted enrollment embeddings that reflect the DNN technique.

In operation 306, the server generates and stores voiceprint(s) for a user profile by combining converted embedding(s). The server algorithmically combines the converted embeddings (e.g., determines an average) to generate a converted voiceprint of the second type of embedding. The server stores the converted voiceprint into the user profile of the enrollee, in a database.

After completing the enrollment phase by generating the converted embeddings and voiceprints for the enrollee, the server then places the machine-learning architecture into a deployment phase.

In operation 308, the server receives an inbound signal, extracts inbound features from the inbound signals, and extracts an inbound voiceprint embedding by applying the second embedding extractor. The input layers of the machine-learning architecture perform the various pre-processing operations for ingesting the inbound signal and extracting the inbound features. The pre-processing operations may include, for example, extracting low-level features from the enrollment audio signals and transforming such features from a time-domain representation into a frequency-domain representation by executing a transform operation, such as Fast-Fourier Transform (FFT) or Sparse-Fourier Transform (SFT) operations. The pre-processing operations may also include parsing the inbound signal into frames or sub-frames, and performing various normalization or scaling operations. Optionally, the server performs any number of pre-processing operations prior to feeding the inbound signal into the input layers of the machine-learning architecture.

For example, where the inbound signal has 16 kHz sampling rate, the inbound voiceprint embedding reflects the 16 kHz inbound signal and a second embedding extractor is trained to extract the inbound voiceprint based upon the 16 kHz sampling rate. As another example, the second embedding extractor includes layers implementing the DNN technique, trained to extract the inbound embedding that reflects the DNN technique implemented by the second embedding extractor.

In operation 312, the server generates a similarity score based on the inbound voiceprint and the converted voiceprint for the enrollee stored in the database. The server applies scoring layers of the machine-learning architecture on the inbound voiceprint and the converted voiceprint, where the inbound voiceprint and the converted voiceprint include the same type of embedding. Continuing with the earlier examples, both the inbound voiceprint and the converted voiceprint include embeddings based upon a vector space for 16 kHz signals or based upon the DNN technique of the second embedding extractor.

The scoring layers generate, for example, a similarity score indicating the similarity (e.g., cosine distance) between the inbound voiceprint (of the inbound speaker) and the converted embedding (of the enrollee-speaker). The server identifies a match (or a likely match) between the inbound speaker and the enrollee when the similarity score satisfies a threshold value. In some embodiments, one or more downstream operations (e.g., speaker authentication, speaker diarization) reference the match determination, the similarity score, and/or the inbound voiceprint to perform the particular downstream operations.

Enrollment Embeddings and Authentication Operations

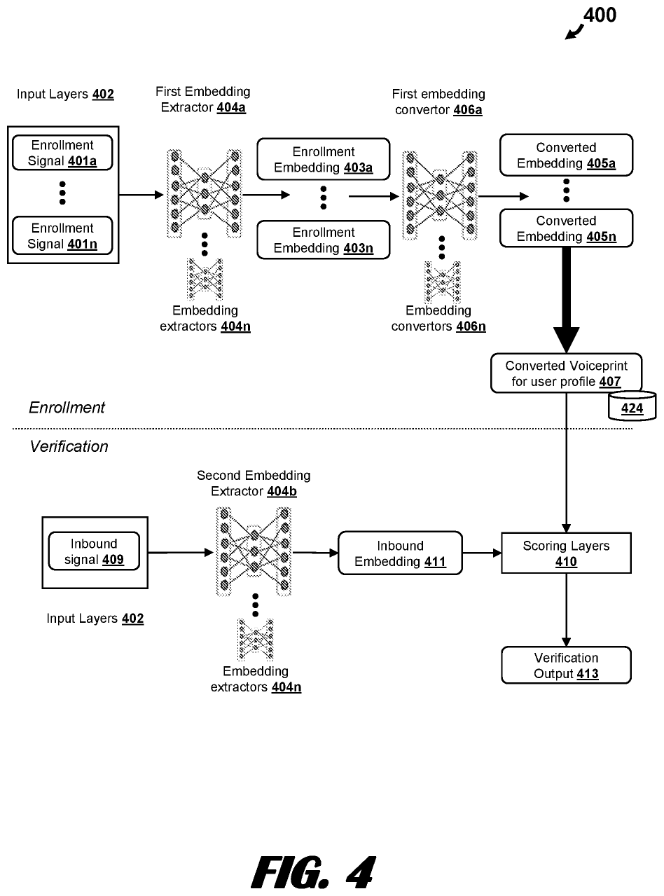

FIG. 4 shows data flow amongst layers of a machine-learning architecture 400 for speaker recognition including embedding convertors. Components of the machine-learning architecture 400 comprises input layers 402, any number of embedding extractors 404 (e.g., first embedding extractor 404a, second embedding extractor 404b), any number of embedding convertors 406a-406n (collectively referred to as “embedding convertors 406”), and scoring layers 410. For ease of description, the machine-learning architecture 400 is described as a single machine-learning architecture 400, though embodiments may comprise a plurality of distinct machine-learning architectures 400 comprising software programming for performing the functions described herein. Moreover, embodiments may comprise additional or alternative components or functional layers than those described herein.

The machine-learning architecture 400 is described as being executed by a server during enrollment and deployment operational phases for enrolling a new enrollee-speaker using enrollment signals 401a-401n (collectively referred to as “enrollment signals 401”) and verifying an inbound speaker using an inbound signal 409. However, any computing device comprising a processor capable of performing the operations of the machine-learning architecture 400 may execute components of the machine-learning architecture 400. Moreover, any number of such computing devices may perform the functions of the machine-learning architecture 400. The machine-learning architecture 400 includes input layers 402 for ingesting the audio signals 401, 409, which includes layers for pre-processing (e.g., feature extraction, feature transforms) and data augmentation operations; layers that define any number of embedding extractors 404 (e.g., first embedding extractor 404a, second embedding extractor 404b) for generating speaker embeddings 403, 411; layers that define embedding convertors 406a-406n (collectively referred to as “embedding convertors 406”); and one or more scoring layers 410 that perform various scoring and verification operations, such as a distance scoring operation, to produce one or more verification outputs 413.

The input layers 402 perform one or more pre-processing operations on the input audio signals 401, 409 (e.g., enrollment signals 401, inbound signals 409), such as parsing the input audio signals 401, 409 into frames or segments, extracting low-level features, and transforming the input audio signals 401, 409 from a time-domain representation to a frequency-domain (or energy domain) representation, among other pre-processing operations.

During the enrollment phase, the input layers 402 receive the enrollment audio signals 401 for the enrollee. In some implementations, the input layers 402 perform data augmentation operations on the enrollment audio signals 401 to, for example, manipulate the audio signals within the enrollment audio signals 401, manipulate the low-level features, or generate simulated enrollment audio signals 401 that have manipulated features or audio signal based on corresponding enrollment audio signals 401. An enrollee-speaker contacts a service provider's system and supplies several example enrollment signals 401. For example, the speaker responds to various questions or prompts with spoken responses that serve as the enrollment signals 401, where the service provider system presents the questions or prompts to the enrollee by an IVR system or by a human agent of the service provider system. The server receives the enrollee's spoken responses in the enrollment signals 401. The server feeds the resulting enrollment signals 401 into the input layers 402 to begin applying machine-learning architecture 400.

During the deployment phase, the input layers 402 may perform the pre-processing operations to prepare an inbound signal 409 for the embedding extractor 404. The server may disable some or all of the pre-processing and/or augmentation operations of the input layers 402, such that the second embedding extractor 404b evaluates the features of the inbound signal 409 as received.

The embedding extractors 404 include layers that extract embedding based upon the types of attributes of the input signals (e.g., enrollment signals 401, inbound signal 409) or the types of embeddings (e.g., GMM-based embeddings, DNN-based embeddings). Each embedding extractor 404 comprises one or more layers of the machine-learning architecture 400 trained (during a training phase) to detect speech, extract features, and generate feature vectors based on the features extracted from the input audio signals 401, 409.

During the enrollment phase, the embedding extractor 404 outputs the feature vectors as enrollment embeddings 403 or as enrolled voiceprints. The server applies the one or more embedding extractors 404 on the features extracted from each of the enrollment signals 401 to produce enrollment feature vectors (e.g., enrollment embeddings 403, voiceprints). In some implementations, the embedding extractor 404 (or other layers of the machine-learning architecture 400) performs various statistical or algorithmic operations to combine the enrollment embeddings 403 of the same type (i.e., generated from the same embedding extractor 404) to generate a corresponding enrolled voiceprint (not shown) for a user profile of the enrollee.

For instance, the server applies the first embedding extractor 404a on the enrollment signals 401 to extract the enrollment embeddings 403 of the first type of embeddings, as generated by the first embedding extractor 404a. The first embedding extractor 404a (or other layers of the machine-learning architecture 400) algorithmically combines the first type of enrollment embeddings 403 to form a first type of enrolled voiceprint (not shown), which the server stores into the user profile in a database 424 or other non-transitory storage medium. The machine-learning architecture 400 may reference the first-type of enrollment embeddings 403 or the first type of enrolled voiceprint (not shown) during the deployment phase, allowing the server to verify an inbound speaker of a future, inbound signal 409 using the first embedding extractor 404a and the scoring layers 410.

The embedding convertors 406 include layers of machine-learning architecture 400 that convert a first type of embedding to a second type of embedding. The machine-learning architecture 400 includes any number of embedding convertors 406, where the amount of embedding convertors 406 is based upon the number of trained embedding extractors 404 employed by the machine-learning architecture 400. For instance, where the server employs two embedding extractors 404, the machine-learning architecture 400 may include one or two embedding convertors 406. Each embedding convertor 406 is trained to take an enrollment embedding 403 of a particular type of embedding as input, and generate corresponding converted enrollment embeddings 405 of a different type of embedding. For instance, the embedding convertor 406 takes as input the enrollment embeddings 403 of the first type of embedding (produced by the first embedding extractor 404a) and outputs the converted enrollment embeddings 405 of the second type of embedding (produced by the second embedding extractor 404b). The embedding convertor 406 (or other layers of the machine-learning architecture 400) algorithmically combines the converted enrollment embeddings 405 of the second to generate a converted enrolled voiceprint 407 of the different type of embedding for the enrollee-user. The server stores the converted enrollment embeddings 405 and/or the converted enrolled voiceprints 407 for future reference during the deployment phase. The server may apply the embedding convertors 406 at any point-in-time after generating the enrollment embeddings 403.

As an example, the first embedding extractor 404a is trained to extract embeddings based on 8 kHz input signals (as the first type of embedding), and the second embedding extractor 404b is trained to extract embeddings based on 16 kHz input signals (as the second type of embedding). In this example, the first embedding extractor 404a extracts the enrollment embeddings 403 based on the 8 kHz enrollment signals 401. A first embedding convertor 406a is trained to take the 8 kHz-based enrollment embeddings 403 as input and generate the corresponding converted enrollment embeddings 405 as the second type of embedding (as though generated by the second embedding extractor 404b using 16 kHz audio signals).

As another example, the first embedding extractor 404a includes a trained GMM for extracting embeddings (as the first type of embedding), and the second embedding extractor 404b includes a trained neural network architecture for extracting embeddings (as the second type of embedding). In this example, the first embedding convertor 406a is trained to take the first type of enrollment embeddings 403 (GMM-based embeddings) as input, and generate the corresponding converted enrollment embeddings 405 of the second type of embedding (DNN-based embeddings, as though generated by the second embedding extractor 404b).

The scoring layers 410 perform various scoring operations and generating various types of verification outputs 413 for an inbound signal 409 involving an inbound speaker. The second embedding extractor 404b extracts an inbound voiceprint 411 representing the features extracted from the inbound signal 409. The scoring layers 410 perform a distance scoring operation that determines the distance (e.g., similarities, differences) between the converted enrolled voiceprint 407 stored in the voiceprint database 424 and the inbound voiceprint 411, indicating the likelihood that the inbound speaker is the enrollee. For instance, a lower distance score (or higher similarity score) for the inbound signal 409 indicates nearer or more similarities between the converted enrolled voiceprint 407 and the inbound voiceprint 411, thereby indicating a higher-likelihood that the inbound speaker is the enrollee. The scoring layer 410 may generate and produce a verification output 413 based upon the scoring operations. The verification output(s) 413 may include, for example, a value generated by the scoring layer 410 based upon one or more scoring operations (e.g., cosine distance scoring), visual indicator for a GUI, and/or instructions or data for a downstream application.

During the deployment phase, the input layer 402 extracts the inbound features for the inbound signal 409 and performs various pre-processing operations on the inbound features, such as a transform operation (e.g., Fast-Fourier Transform). The server applies the second embedding extractor 404b on the inbound features and extracts the inbound voiceprint 411 for the inbound speaker. To verify or authenticate the inbound speaker of the inbound signal 409 as the enrolled speaker, the server applies the scoring layer 410 on the inbound voiceprint 411 (for the inbound speaker) and the converted enrolled voiceprint 407 (for the enrolled speaker). The scoring layer 410 performs various scoring operations to generate one or more verification outputs 413, which includes a scoring operation that generates similarity score that indicates the similarity (e.g., cosine distance) between the inbound voiceprint 411 and the converted enrolled voiceprint 407. The scoring layers 410 determine whether the similarity score or other outputted values satisfy corresponding threshold values.

The verification output 413 need not be a numeric output. For example, the verification output 413 may be a human-readable indicator (e.g., plain language, visual display) that indicates whether the machine-learning architecture 400 has recognized or authenticated the inbound speaker as the enrolled speaker. As another example, the verification output 413 may include a machine-readable detection indicator or authentication instruction, which the server transmits via one or more networks to computing devices performing one or more downstream applications.

In some embodiments, a computer-implemented method comprises obtaining, by a computer, a plurality of enrollment embeddings extracted using a plurality of enrollment signals for an enrolled user by applying a first embedding extractor for a first attribute-type; generating, by the computer, a plurality of converted embeddings corresponding to the plurality of enrollment embeddings by applying an embedding convertor comprising a plurality of machine-learning layers trained to generate a converted embedding having a second attribute-type for an enrollment embedding having a first attribute-type; generating, by the computer, a converted enrolled voiceprint having the second attribute-type for the enrolled user based upon the plurality of converted embeddings; generating, by the computer, an inbound voiceprint for an inbound user extracted using an inbound signal for an inbound user by applying a second embedding extractor for the second attribute-type; and generating, by the computer, a similarity score for the inbound signal using the converted enrolled voiceprint and the inbound voiceprint, the similarity score indicating a likelihood that the inbound user is the enrolled user.

In some implementations, the method comprises obtaining, by the computer, a plurality of training embeddings extracted using a plurality of training signals by applying the first embedding extractor for the first attribute-type; and training, by the computer, the embedding convertor by applying the machine-learning layers of the embedding convertor on the plurality of training embeddings.

In some implementations, training the embedding extractor includes performing, by the computer, a loss function of the embedding extractor according to a predicted converted embedding outputted by the embedding extractor for a training audio signal, the loss function instructing the computer to update one or more hyper-parameters of one or more layers of the embedding extractor.

In some implementations, training the embedding extractor includes executing, by the computer, one or more data augmentation operations on at least of a training audio signal and an enrollment signal.

In some implementations, the computer trains a plurality of embedding convertors according to a plurality of attribute-types.

In some implementations, the computer generates a plurality of converted enrolled voiceprints by applying the plurality of embedding convertors corresponding to the plurality of attribute-types on the plurality of embedding signals.

In some implementations, the method further comprises identifying, by the computer, the second attribute-type of the inbound embedding; and selecting, by the computer, the converted enrolled voiceprint from a plurality of converted enrolled voiceprints according to the second attribute-type.

In some implementations, generating the converted enrolled voiceprint having the second attribute-type includes storing, by the computer, the converted enrolled voiceprint into a user profile database.

In some implementations, generating the converted enrolled voiceprint having the second attribute-type includes algorithmically combining, by the computer, the converted enrollment embeddings having the second attribute-type.

In some implementations, generating a plurality of converted embeddings includes, for each enrollment signal: extracting, by the computer, a set of enrollment features from an enrollment signal; and extracting, by the computer, an enrollment embedding based upon the set of features extracted from the enrollment audio signal by applying the first embedding extractor for the first attribute-type.

In some embodiments, a system comprises a non-transitory machine-readable memory configured to store machine-readable instructions for one or more neural networks; and a computer comprising a processor. The computer configured to obtain a plurality of enrollment embeddings extracted using a plurality of enrollment signals for an enrolled user by applying a first embedding extractor for a first attribute-type; generate a plurality of converted embeddings corresponding to the plurality of enrollment embeddings by applying an embedding convertor comprising a plurality of machine-learning layers trained to generate a converted embedding having a second attribute-type for an enrollment embedding having a first attribute-type; generate a converted enrolled voiceprint having the second attribute-type for the enrolled user based upon the plurality of converted embeddings; generate an inbound voiceprint for an inbound user extracted using an inbound signal for an inbound user by applying a second embedding extractor for the second attribute-type; and generate a similarity score for the inbound signal using the converted enrolled voiceprint and the inbound voiceprint, the similarity score indicating a likelihood that the inbound user is the enrolled user.

In some implementations, the computer is further configured to obtain a plurality of training embeddings extracted using a plurality of training signals by applying the first embedding extractor for the first attribute-type; and train the embedding convertor by applying the machine-learning layers of the embedding convertor on the plurality of training embeddings.

In some implementations, when training the embedding extractor the computer is further configured to perform a loss function of the embedding extractor according to a predicted converted embedding outputted by the embedding extractor for a training audio signal, the loss function instructing the computer to update one or more hyper-parameters of one or more layers of the embedding extractor.

In some implementations, when training the embedding extractor the computer is further configured to execute one or more data augmentation operations on at least of a training signal and an enrollment signal.

In some implementations, the computer trains a plurality of embedding convertors according to a plurality of attribute-types.

In some implementations, the computer generates a plurality of converted enrolled voiceprints by applying the plurality of embedding convertors corresponding to the plurality of attribute-types on the plurality of embedding signals.

In some implementations, the computer is further configured to identify the second attribute-type of the inbound embedding; and select the converted enrolled voiceprint from a plurality of converted enrolled voiceprints according to the second attribute-type.

In some implementations, when generating the converted enrolled voiceprint having the second attribute-type the computer is further configured to store the converted enrolled voiceprint into a user profile database.

In some implementations, when generating the converted enrolled voiceprint having the second attribute-type the computer is further configured to algorithmically combine the converted enrollment embeddings having the second attribute-type.

In some implementations, when generating a plurality of converted embeddings the computer is further configured to, for each enrollment signal: extract a set of enrollment features from an enrollment signal; and extract an enrollment embedding based upon the set of features extracted from the enrollment audio signal by applying the first embedding extractor for the first attribute-type.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
obtaining, by a computer, a plurality of enrollment embeddings extracted using a plurality of enrollment signals for an enrolled user by applying a first embedding extractor for a first attribute-type;
generating, by the computer, a plurality of converted embeddings corresponding to the plurality of enrollment embeddings by applying an embedding convertor comprising a plurality of machine-learning layers trained to generate a converted embedding having a second attribute-type for an enrollment embedding having a first attribute-type;
generating, by the computer, a converted enrolled voiceprint having the second attribute-type for the enrolled user based upon the plurality of converted embeddings;
generating, by the computer, an inbound voiceprint for an inbound user extracted using an inbound signal for an inbound user by applying a second embedding extractor for the second attribute-type; and
generating, by the computer, a similarity score for the inbound signal using the converted enrolled voiceprint and the inbound voiceprint, the similarity score indicating a likelihood that the inbound user is the enrolled user.

2. The method according to claim 1, further comprising:
obtaining, by the computer, a plurality of training embeddings extracted using a plurality of training signals by applying the first embedding extractor for the first attribute-type; and
training, by the computer, the embedding convertor by applying the machine-learning layers of the embedding convertor on the plurality of training embeddings.

3. The method according to claim 2, wherein training the embedding extractor includes:
performing, by the computer, a loss function of the embedding extractor according to a predicted converted embedding outputted by the embedding extractor for a training audio signal, the loss function instructing the computer to update one or more hyper-parameters of one or more layers of the embedding extractor.

4. The method according to claim 2, wherein training the embedding extractor includes executing, by the computer, one or more data augmentation operations on at least of a training audio signal and an enrollment signal.

5. The method according to claim 1, wherein the computer trains a plurality of embedding convertors according to a plurality of attribute-types.

6. The method according to claim 5, wherein the computer generates a plurality of converted enrolled voiceprints by applying the plurality of embedding convertors corresponding to the plurality of attribute-types on the plurality of embedding signals.

7. The method according to claim 5, further comprising:
identifying, by the computer, the second attribute-type of the inbound embedding; and
selecting, by the computer, the converted enrolled voiceprint from a plurality of converted enrolled voiceprints according to the second attribute-type.

8. The method according to claim 1, wherein generating the converted enrolled voiceprint having the second attribute-type includes storing, by the computer, the converted enrolled voiceprint into a user profile database.

9. The method according to claim 1, wherein generating the converted enrolled voiceprint having the second attribute-type includes algorithmically combining, by the computer, the converted enrollment embeddings having the second attribute-type.

10. The method according to claim 1, wherein generating a plurality of converted embeddings includes, for each enrollment signal:
extracting, by the computer, a set of enrollment features from an enrollment signal; and
extracting, by the computer, an enrollment embedding based upon the set of features extracted from the enrollment audio signal by applying the first embedding extractor for the first attribute-type.

11. A system comprising:
a non-transitory machine-readable memory configured to store machine-readable instructions for one or more neural networks; and
a computer comprising a processor configured to:
obtain a plurality of enrollment embeddings extracted using a plurality of enrollment signals for an enrolled user by applying a first embedding extractor for a first attribute-type;
generate a plurality of converted embeddings corresponding to the plurality of enrollment embeddings by applying an embedding convertor comprising a plurality of machine-learning layers trained to generate a converted embedding having a second attribute-type for an enrollment embedding having a first attribute-type;
generate a converted enrolled voiceprint having the second attribute-type for the enrolled user based upon the plurality of converted embeddings;
generate an inbound voiceprint for an inbound user extracted using an inbound signal for an inbound user by applying a second embedding extractor for the second attribute-type; and
generate a similarity score for the inbound signal using the converted enrolled voiceprint and the inbound voiceprint, the similarity score indicating a likelihood that the inbound user is the enrolled user.

12. The system according to claim 11, wherein the computer is further configured to:
obtain a plurality of training embeddings extracted using a plurality of training signals by applying the first embedding extractor for the first attribute-type; and
train the embedding convertor by applying the machine-learning layers of the embedding convertor on the plurality of training embeddings.

13. The system according to claim 12, wherein when training the embedding extractor the computer is further configured to:
perform a loss function of the embedding extractor according to a predicted converted embedding outputted by the embedding extractor for a training audio signal, the loss function instructing the computer to update one or more hyper-parameters of one or more layers of the embedding extractor.

14. The system according to claim 12, wherein when training the embedding extractor the computer is further configured to execute one or more data augmentation operations on at least of a training signal and an enrollment signal.

15. The system according to claim 11, wherein the computer trains a plurality of embedding convertors according to a plurality of attribute-types.

16. The system according to claim 15, wherein the computer generates a plurality of converted enrolled voiceprints by applying the plurality of embedding convertors corresponding to the plurality of attribute-types on the plurality of embedding signals.

17. The system according to claim 15, wherein the computer is further configured to:
identify the second attribute-type of the inbound embedding; and
select the converted enrolled voiceprint from a plurality of converted enrolled voiceprints according to the second attribute-type.

18. The system according to claim 11, wherein when generating the converted enrolled voiceprint having the second attribute-type the computer is further configured to store the converted enrolled voiceprint into a user profile database.

19. The system according to claim 11, wherein when generating the converted enrolled voiceprint having the second attribute-type the computer is further configured to algorithmically combine the converted enrollment embeddings having the second attribute-type.

20. The system according to claim 11, wherein when generating a plurality of converted embeddings the computer is further configured to, for each enrollment signal:
extract a set of enrollment features from an enrollment signal; and
extract an enrollment embedding based upon the set of features extracted from the enrollment audio signal by applying the first embedding extractor for the first attribute-type.
